(19) United States
(12) Patent Application Publication
(10) Pub. No.: US 2026/0262116 A1
(43) Pub. Date: Sep. 3, 2026

(54) COMMUNICATION TERMINAL APPARATUS, TETHERING PROCESSING METHOD, AND PROGRAM

(71) Applicant: SONY GROUP CORPORATION, TOKYO (JP)

(72) Inventors: SHOTA KAMEYAMA, TOKYO (JP); TOMOHARU HATANO, TOKYO (JP); MASAYA SUZUKI, TOKYO (JP)

(21) Appl. No.: 19/163,774

(22) PCT Filed: Mar. 15, 2024
(86) PCT No.: PCT/JP2024/010270

§ 371 Date: Sep. 9, 2025

(30) Foreign Application Priority Data
Mar. 29, 2023 (JP) 2023-053326

(51) Int. Cl. H04W 76/14; H04W 24/04; H04W 64/00; H04W 84/20

(52) U.S. Cl. CPC H04W 76/14; H04W 24/04; H04W 64/006; H04W 84/20

(57) ABSTRACT

A communication terminal apparatus includes a tethering processing unit configured to transmit a master device request signal to a communication terminal apparatus that is not executing tethering as a master device, and perform processing of starting tethering as a slave device via a tethering master device determined among communication terminal apparatuses to which the master device request signal is transmitted.

### TECHNICAL FIELD

The present technology relates to a technical field of a communication terminal apparatus, a tethering processing method, and a program.

### BACKGROUND ART

Patent Document 1 below describes a technology of acquiring information regarding tethering from a plurality of tethering master devices in the surroundings, selecting an optimal master device as a connection destination, and connecting to the master device.

### CITATION LIST

### Patent Document

Patent Document 1: Japanese Patent Application Laid-Open No. 2012-227610

### SUMMARY OF THE INVENTION

### Problems to be Solved by the Invention

However, the above technology is based on a premise that a plurality of master devices that has activated tethering exists in the surroundings, and a technology for continuing network connection even in a situation where there is no access point in the surroundings has not been proposed. In a case where no access point exists in the surroundings, if a tethering master device disappears during tethering, a communication terminal apparatus connected as a slave device will no longer be able to connect to the network. For example, if one of family members goes out with the activated tethering device, a situation where remaining family members cannot establish network connection may occur.

Therefore, the present disclosure proposes a technology for easily executing tethering in a situation where a tethering master device does not exist.

### Solutions to Problems

A communication terminal apparatus according to the present technology includes a tethering processing unit configured to transmit a master device request signal to a communication terminal apparatus that is not executing tethering as a master device, and perform processing of starting tethering as a slave device via a tethering master device determined among communication terminal apparatuses to which the master device request signal is transmitted.

In a situation where a tethering master device disappears during tethering as a slave device, or in a situation where it is desired to start tethering as a slave device in a state where a tethering master device disappears, a master device request signal to a peripheral communication terminal apparatus is transmitted, and tethering is started via a master device determined by using the master device request signal as a trigger.

### BRIEF DESCRIPTION OF DRAWINGS

FIG. 1 is an explanatory diagram of a change of a master device according to an embodiment of the present technology.

FIG. 2 is an explanatory diagram of a first sequence example according to the embodiment.

FIG. 3 is an explanatory diagram of an operation screen for a preset group according to the embodiment.

FIG. 4 is an explanatory diagram of a second sequence example according to the embodiment.

FIG. 5 is an explanatory diagram of a display example of connection destination candidates according to the embodiment.

FIG. 6 is an explanatory diagram of a third sequence example according to the embodiment.

FIG. 7 is an explanatory diagram of a fourth sequence example according to the embodiment.

FIG. 8 is an explanatory diagram of tethering at the time of failure according to the embodiment.

FIG. 9 is an explanatory diagram of a fifth sequence example according to the embodiment.

FIG. 10 is an explanatory diagram of tethering at an outside of a communication range according to the embodiment.

FIG. 11 is an explanatory diagram of a sixth sequence example according to the embodiment.

FIG. 12 is an explanatory diagram of a seventh sequence example according to the embodiment.

FIG. 13 is an explanatory diagram of an eighth sequence example according to the embodiment.

FIG. 14 is an explanatory diagram of an operation screen of an all-permission mode according to the embodiment.

FIG. 15 is an explanatory diagram of tethering in a specific area according to the embodiment.

FIG. 16 is an explanatory diagram of a ninth sequence example according to the embodiment.

FIG. 17 is a block diagram of a communication terminal apparatus according to the embodiment.

FIG. 18 is a flowchart illustrating a processing example when the communication terminal apparatus according to the embodiment is a tethering slave device.

FIG. 19 is a flowchart illustrating a processing example when the communication terminal apparatus according to the embodiment receives a master device request signal.

FIG. 20 is a flowchart illustrating a processing example of the all-permission mode of the communication terminal apparatus according to the embodiment.

### MODE FOR CARRYING OUT THE INVENTION

Hereinafter, an embodiment will be described in the following order.
<1. Case of searching tethering master device and resuming tethering>
<2. Tethering at time of network failure>
<3. Tethering at outside of communication range or like>
<4. Tethering in specific area>
<5. Configuration of communication terminal apparatus>
<6. Processing example of communication terminal apparatus>
<7. Summary and modifications>

### 1. Case of Searching Tethering Master Device and Resuming Tethering

In the embodiment, processing in a case where tethering is performed by a communication terminal apparatus such as a smartphone in various types of cases will be described.

A first case is a case where, when a certain communication terminal apparatus is tethering as a slave device, if a tethering master device is not found, that is, a so-called beacon loss occurs, a surrounding communication terminal apparatus that is not tethering as a master device is requested to serve as a master device, and tethering is resumed.

Note that examples of the communication terminal apparatus to which the technology of the present disclosure can be applied include various types of devices such as a smartphone, a mobile phone, a game machine, a tablet terminal, and a personal computer. For example, application to a device that performs network communication by contracting with a telecommunication carrier is preferable.

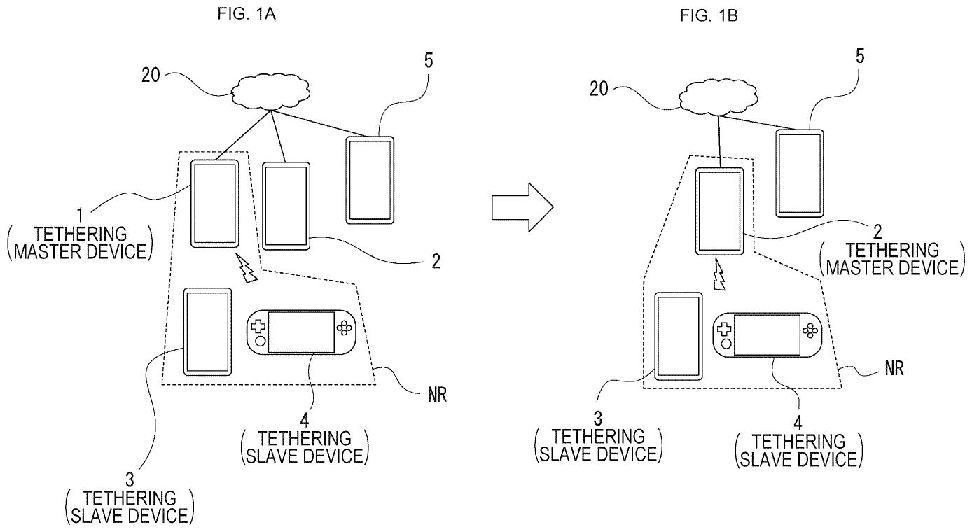

A case where a tethering master device disappears will be described with reference to FIGS. 1A and 1B.

FIG. 1A illustrates smartphones 1, 2, 3, and 5 and a game machine 4 as communication terminal apparatuses that are enabled to perform, for example, Internet communication or the like by a network 20.

In this case, it is assumed that the smartphone 1 serves as a master device, and the smartphone 3 and the game machine 4 serve as slave devices to perform tethering. A network range NR of the tethering is indicated by a broken line. The smartphones 2 and 5 do not perform tethering neither as a master device nor as a slave device.

From the situation of FIG. 1A, it is assumed that the smartphone 3 and the game machine 4 are no longer able to perform tethering due to a user of the smartphone 1, which has been a tethering master device, going to a distant place or the like.

For example, in this case, the smartphone 3 outputs a master device request signal (master device request signal Sq1 to be described later) to the smartphones 2 and 5 and the game machine 4 which are peripheral communication terminal apparatuses, and a new master device is set through various types of processing.

FIG. 1B illustrates a state where the smartphone 2 is set as the new master device, whereby the smartphone 3 and the game machine 4 resume tethering.

In this way, even if the master device disappears during tethering, the smartphone 3 and the game machine 4 can resume tethering by using a surrounding communication terminal apparatus that is capable of tethering as a master device.

Sequence examples of each communication terminal apparatus corresponding to such a case will be described.

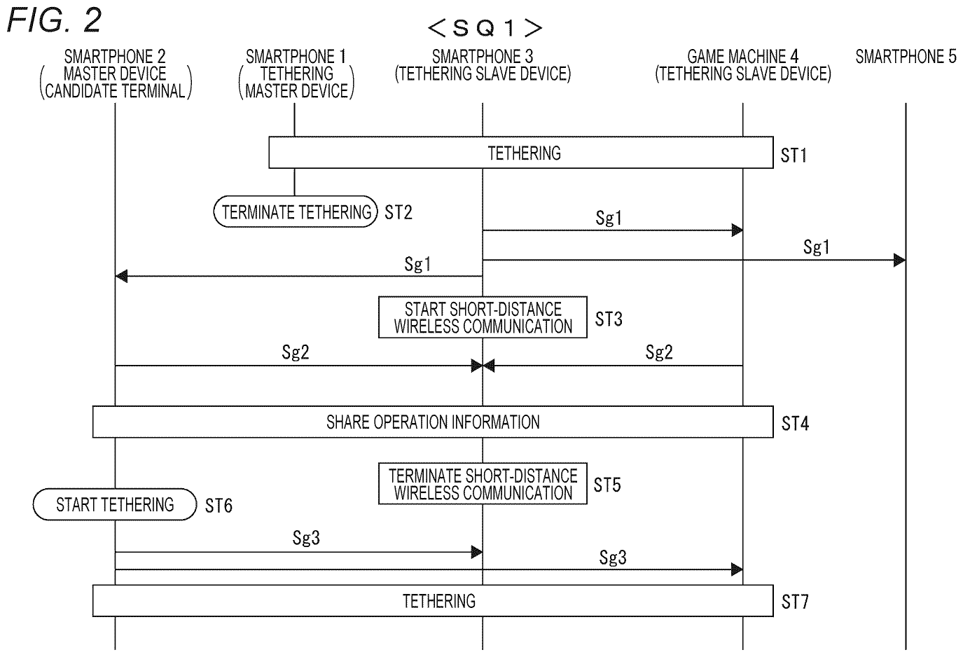

FIG. 2 illustrates a sequence SQ1 as a first sequence example. FIG. 2 illustrates a flow of processing of the smartphones 1, 2, 3, and 5 and the game machine 4 illustrated in FIGS. 1A and 1B.

### State ST1

Initially, the smartphone 1 serves as a master device, and the smartphone 3 and the game machine 4 serve as slave devices to perform tethering.

### State ST2

When a user carrying the smartphone 1 moves or the like, the smartphone 1 can no longer function as a master device, and tethering is terminated.

In this case, in response to interruption of tethering (beacon loss), the smartphone 3, which has been a slave device, transmits a master device request signal Sg1 to peripheral communication terminal apparatuses. For example, in this case, the smartphone 3 transmits the master device request signal Sq1 to the smartphones 2 and 5 and the game machine 4.

### State ST3

After transmitting the master device request signal Sq1, the smartphone 3 starts short-distance wireless communication.

The short-distance wireless communication in this case is assumed to be short-distance wireless network communication such as Wi-Fi Aware (registered trademark) or Bluetooth (registered trademark).

On the other hand, the respective communication terminal apparatuses that have received the master device request signal Sg1 take measures corresponding to respective situations.

Specifically, each communication terminal apparatus determines whether or not the smartphone 3 that is a transmission source of the master device request signal Sq1 belongs to a preset group for the own device.

The preset group indicates a range set in advance in each communication terminal apparatus, and indicates a range of users who are permitted to use the own device as a tethering master device for the communication terminal apparatuses in that group.

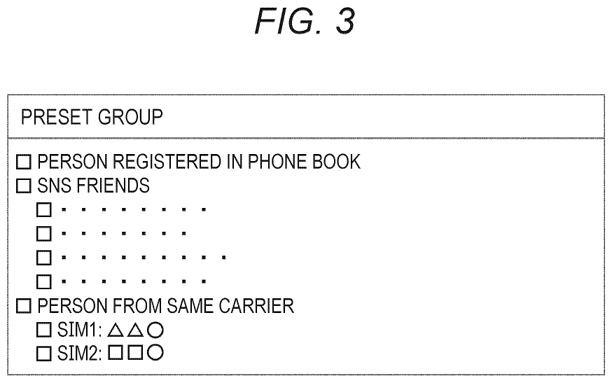

FIG. 3 is a screen example of a preset group that a user can operate in each communication terminal apparatus. For example, the following another users can be selected by a check box.
Person registered in phone book of own communication terminal apparatus
Social networking service (SNS) friends
Person from same carrier (telecommunication carrier) For the SNS, it can be checked for each service. For the carrier, it may be checked for each subscriber identity module (SIM). The above is an example, and for example, check on/off may be enabled for each user registered in the phone book, or a group may be created with a plurality of users and setting can be performed.

In the example of FIG. 2, it is assumed that the smartphone 3 that is the transmission source of the master device request signal Sg1 is included in the preset group for the smartphone 2 and the game machine 4. In this case, the smartphone 2 and the game machine 4 each transmit a participation signal Sg2 for short-distance wireless communication to the smartphone 3, and start communication.

On the other hand, for the smartphone 5, it is assumed that the smartphone 3 that is the transmission source of the master device request signal Sg1 is not included in the preset group.

In this case, the smartphone 5 ignores the master device request signal Sg1.

### State ST4

The smartphone 3, the smartphone 2, and the game machine 4 start the short-distance wireless communication and share their respective pieces of operation information. At this point, the smartphone 2 and the game machine 4 become master device candidates for the smartphone 3.

Therefore, the smartphone 2 and the game machine 4 compare their operation information with each other to determine which becomes a master device.

Examples of the operation information to be shared include the following.
Remaining amount of battery
Remaining amount of contracted communication packet
Wi-Fi capacity (11n/ac/ax, 2.4 GHz/5 GHz, or the like) when operating as master device
Cellular capacity (4G/5G, or the like)
User's schedule (for example, whether or not to leave current location in 30 minutes, or the like) By comparing these elements, it is determined which of the smartphone 2 and the game machine 4 that have become the master device candidates is appropriate as a master device. Although various specific determination algorithms are conceivable, for example, it is conceivable to convert each element into a point, perform weighting for each element, and calculate and compare the points.

Then, the master device candidates determine a master device. In addition, a service set identifier (SSID) and a password for identifying the determined master device as an access point are also determined.

### State ST5

In response to the determination of the master device, the smartphone 3 terminates the short-distance wireless communication.

### State ST6

For example, when the smartphone 2 is determined to be a master device, the smartphone 2 starts tethering as a master device. The smartphone 2 transmits a beacon Sg3 and notifies the surroundings of the SSID.

### State ST7

The smartphone 3 and the game machine 4 confirm the beacon Sg3, transmit a password, and resume tethering using the smartphone 2 as a new master device.

Note that in the sequence SQ1 described above, among the smartphone 3 and the game machine 4, which are slave devices that are no longer able to perform tethering, the smartphone 3 transmits the master device request signal Sg1, but the game machine 4 may transmit the master device request signal Sg1.

In a case where a plurality of slave devices exists, a slave device that has received the master device request signal Sg1 from another device before itself transmits the master device request signal Sg1 may become a master device candidate for the transmission source or may not become a master device candidate. In addition, each slave device may transmit the master device request signal Sg1 to independently find a master device.

In addition, in the sequence SQ1, the slave device (for example, the smartphone 3) automatically transmits the master device request signal Sg1 in response to interruption of tethering. However, for example, a request operation button may be prepared as a user interface, and the master device request signal Sg1 may be transmitted at a timing desired by the user.

The above points are similar for a sequence SQ2 and subsequent sequences.

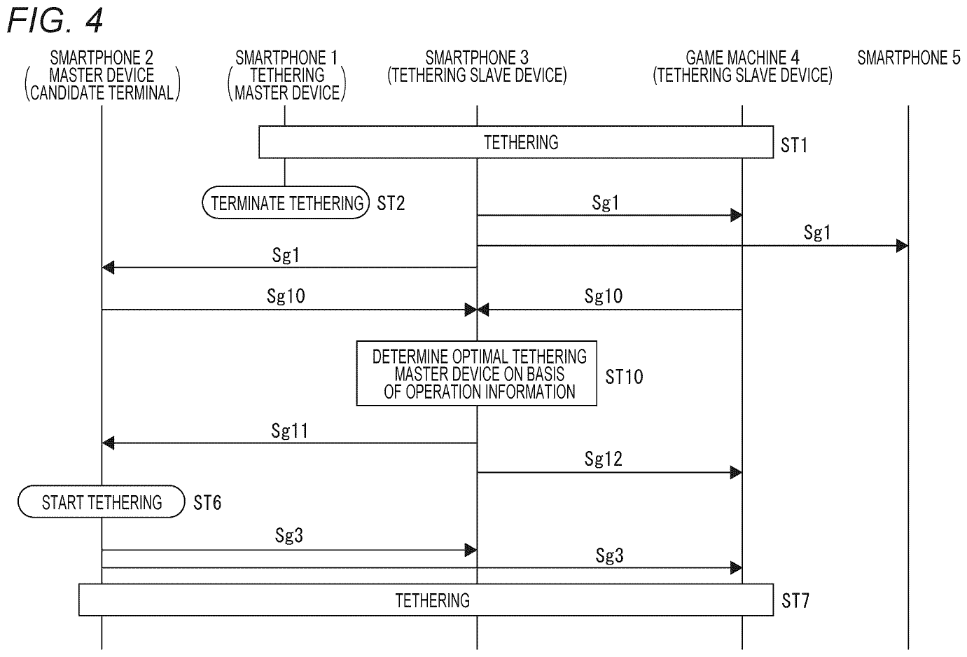

FIG. 4 illustrates a sequence SQ2 as a second sequence example. Similarly to FIG. 2, the flow of processing of the smartphones 1, 2, 3, and 5 and the game machine 4 is illustrated. Note that hereinafter, processing and signals similar to those already described are denoted by the same reference numerals, and redundant description is avoided.

In FIG. 4, the states ST1 and ST2, and the transmission of the master device request signal Sg1 by the smartphone 3 are similar to those in FIG. 2.

The smartphone 2 and the game machine 4 that have received the master device request signal Sq1 from the smartphone 3 which is a communication terminal apparatus in the preset group transmit an operation information signal Sg10 to the smartphone 3 by, for example, unicast communication. The operation information signal Sg10 includes information such as a remaining amount of a battery, a remaining amount of a contracted communication packet, a Wi-Fi capacity when operating as a master device, a cellular capacity, a user's schedule, and the like.

Although the sequence SQ1 of FIG. 2 described above is an example in which these pieces of information are shared between the master device candidates, the sequence SQ2 of FIG. 4 can be said to be a method in which the smartphone 3 aggregates these pieces of information.

### State ST10

The smartphone 3 determines an optimal tethering master device on a basis of the operation information signals Sg10 received from the smartphone 2 and the game machine 4.

For example, the smartphone 3 compares operation information of the smartphone 2 with operation information of the game machine 4 to determine which is appropriate as a master device. Although various specific determination algorithms are conceivable, for example, it is conceivable to convert each element into a point, perform weighting for each element, and calculate and compare the points. Then, the smartphone 3 determines a master device.

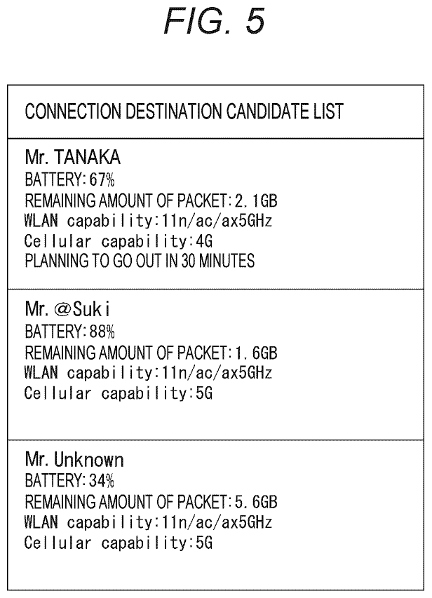

In this case, the user of the smartphone 3 may select a master device. For example, as illustrated in FIG. 5, information regarding respective communication terminal apparatuses as connection destination candidates is displayed on a basis of the operation information signals Sg10 from peripheral communication terminal apparatuses.

For example, a list of master device candidates is displayed, and operation information is also displayed. For example, user names (for example, names of SNS) set in a pre-group are displayed. An unknown user is displayed as, for example, “*** ”, “unknown”, or the like. In addition, the remaining amount of the battery, the remaining amount of the contracted communication packet, the Wi-Fi capacity when operating as the master device, the cellular capacity, the user's schedule, and the like are displayed.

Then, the user selects a master device by a tap operation or the like to determine the master device.

Whether or not a master device is automatically determined or manually determined may be set in advance by the user. For example, a user interface for selecting automatic selection/manual selection may be provided.

In addition, in a case of automatic selection, it is preferable to present information regarding a new master device to the user in a case where the master device is selected.

As described above, the smartphone 3 determines a master device automatically or in response to the user operation. In addition, an SSID and a password are also set.

The smartphone 3 transmits a tethering start request signal Sg11 to the smartphone 2 set as the master device.

In addition, the smartphone 3 transmits a tethering information signal Sg12 to the game machine 4 that has not been set as the master device.

The SSID and the password are also included in the tethering start request signal Sg11 and the tethering information signal Sg12.

### State ST6

In response to receiving the tethering start request signal Sg11, the smartphone 2 starts tethering as a master device. The smartphone 2 transmits a beacon Sg3 and notifies the surroundings of the SSID.

Note that in this case, for example, the smartphone 2 requested to serve as the master device may be able to reject the request. In that case, it is conceivable that the smartphone 3 that made the request transmits the tethering start request signal Sg11 to the next candidate.

### State ST7

The smartphone 3 and the game machine 4 confirm the beacon Sg3, transmit a password, and resume tethering using the smartphone 2 as a new master device.

In the sequence SQ1 of FIG. 2 described above, the tethering master device is determined by the master device candidates, but in the sequence SQ2 of FIG. 4, the smartphone 3 that has transmitted the master device request signal Sq1 determines a master device.

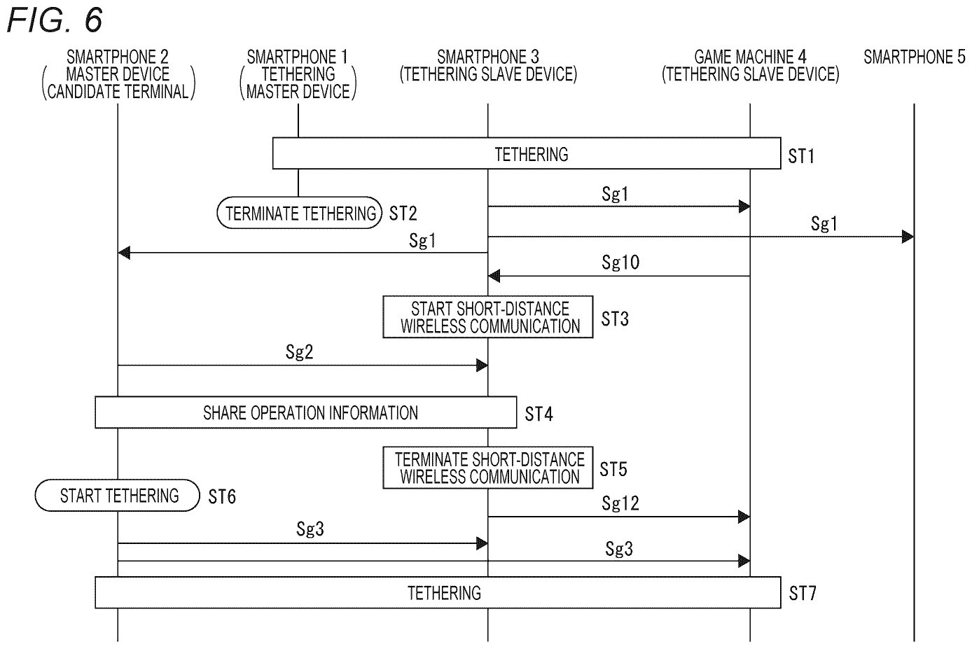

FIG. 6 illustrates a third sequence SQ3. This is an example in which the sequences SQ1 and SQ2 are combined.

In FIG. 6, the states ST1 and ST2, and the transmission of the master device request signal Sg1 by the smartphone 3 are similar to those in FIGS. 2 and 4.

In addition, the smartphone 3 starts short-distance wireless communication as the state ST3.

The game machine 4 that has received the master device request signal Sg1 from the smartphone 3 which is a communication terminal apparatus in the preset group transmits an operation information signal Sg10 to the smartphone 3. This is a case where the game machine 4 is a device not compatible with the short-distance wireless communication started by the smartphone 3.

In addition, the smartphone 2 that has received the master device request signal Sg1 from the smartphone 3 which is a communication terminal apparatus in the preset group transmits a participation signal Sg2 for the short-distance wireless communication to the smartphone 3, and starts communication.

### State ST4

The smartphone 3 and the smartphone 2 share the operation information by the short-distance wireless communication. In this case, since the smartphone 3 has received the operation information of the game machine 4, the smartphone 3 can share the operation information of the game machine 4 with the smartphone 2 that is a master device candidate.

Then, for example, the smartphone 2, which is the master device candidate, compares its own operation information with the operation information of the game machine 4 to determine a master device. In addition, an SSID and a password are determined.

### State ST5

In response to the determination of the master device, the smartphone 3 terminates the short-distance wireless communication.

The smartphone 3 transmits a tethering information signal Sg12 to the game machine 4. The tethering information signal Sg12 also includes an SSID and a password.

### State ST6

For example, when the smartphone 2 is determined to be a master device, the smartphone 2 starts tethering as a master device. The smartphone 2 transmits a beacon Sg3 and notifies the surroundings of the SSID.

### State ST7

The smartphone 3 and the game machine 4 confirm the beacon Sg3, transmit a password, and resume tethering using the smartphone 2 as a new master device.

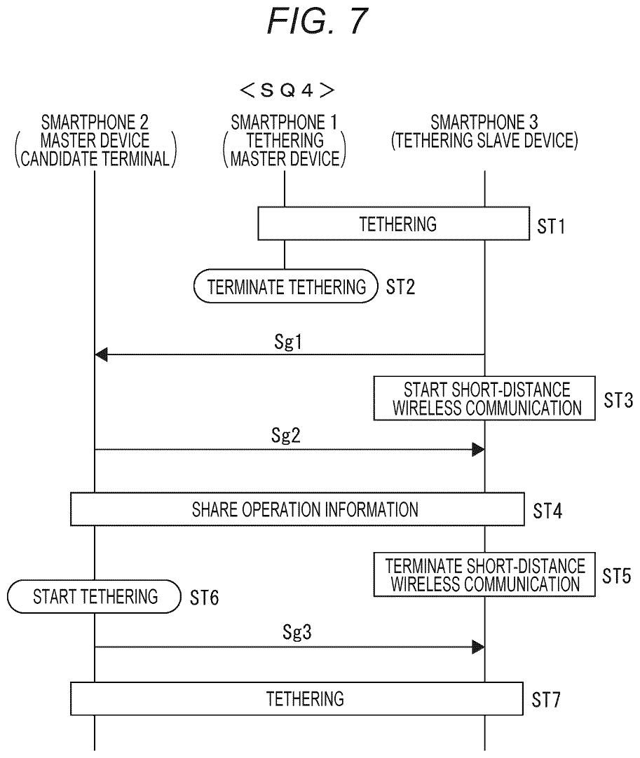

FIG. 7 illustrates a fourth sequence SQ4. Here, as the simplest example, a case where there is one master device candidate is illustrated.

In FIG. 7, the states ST1 and ST2, and the transmission of the master device request signal Sq1 by the smartphone 3 are similar to those in FIGS. 2, 4, and 6. In addition, the smartphone 3 starts short-distance wireless communication as the state ST3.

The smartphone 2 that has received the master device request signal Sq1 from the smartphone 3 which is a communication terminal apparatus in the preset group transmits a participation signal Sg2 for short-distance wireless communication to the smartphone 3, and starts communication.

Then, as a state ST4, the smartphone 3 and the smartphone 2 share operation information by the short-distance wireless communication. Then, for example, the smartphone 2 which is the only master device candidate determines that itself becomes a master device. In addition, an SSID and a password are determined.

As a state ST5, the smartphone 3 terminates the short-distance wireless communication in response to the determination of the master device.

As a state ST6, the smartphone 2 starts tethering as a master device. The smartphone 2 transmits a beacon Sg3 and notifies the surroundings of the SSID.

As a state ST7, the smartphone 3 confirms the beacon Sg3, transmits a password, and resumes tethering using the smartphone 2 as a new master device.

The sequences SQ1, SQ2, SQ3, and SQ4 have been exemplified above, and by such processing, the slave device in which tethering has been interrupted can resume tethering using a communication terminal apparatus that has not been a master device as a new master device.

Therefore, when tethering is interrupted due to the absence of the master device, the slave device such as the smartphone 3 can select an appropriate master device and connect to the Internet via tethering even if no activated access point exists in the surroundings.

### 2. Tethering at Time of Network Failure

Next, tethering at the time of network failure will be described. This is an example in which, in a case where a network failure occurs in a telecommunication carrier due to a disaster or the like, a communication terminal apparatus that has become unable to perform network communication activates tethering using a communication terminal apparatus having a contract for a SIM of another telecommunication carrier.

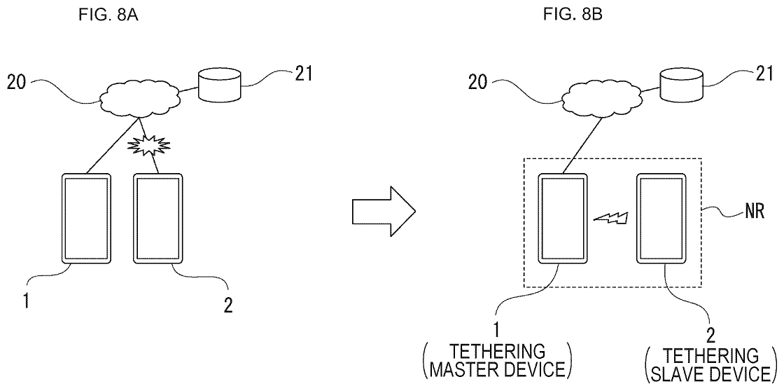

FIG. 8A illustrates smartphones 1 and 2, a network 20, and an operator server 21. The operator is a telecommunication carrier, and the operator server 21 is a server of the telecommunication carrier.

It is assumed that the smartphone 1 and the smartphone 2 are communication terminal apparatuses contracted with different telecommunication carriers.

FIG. 8A illustrates a state where a communication failure occurs in an operator (not illustrated) and the smartphone 2 becomes unable to perform network communication.

In this case, as illustrated in FIG. 8B, the smartphone 2 performs tethering using the smartphone 1 as a master device, and enables execution of network communication.

In addition, on the assumption of a disaster or the like, the communicable operator server 21 performs control to set a communication terminal apparatus of a contractor to an all-permission mode. The all-permission mode is a mode that also responds to a master device request signal Sg1 from a communication terminal apparatus that is not included in the preset group.

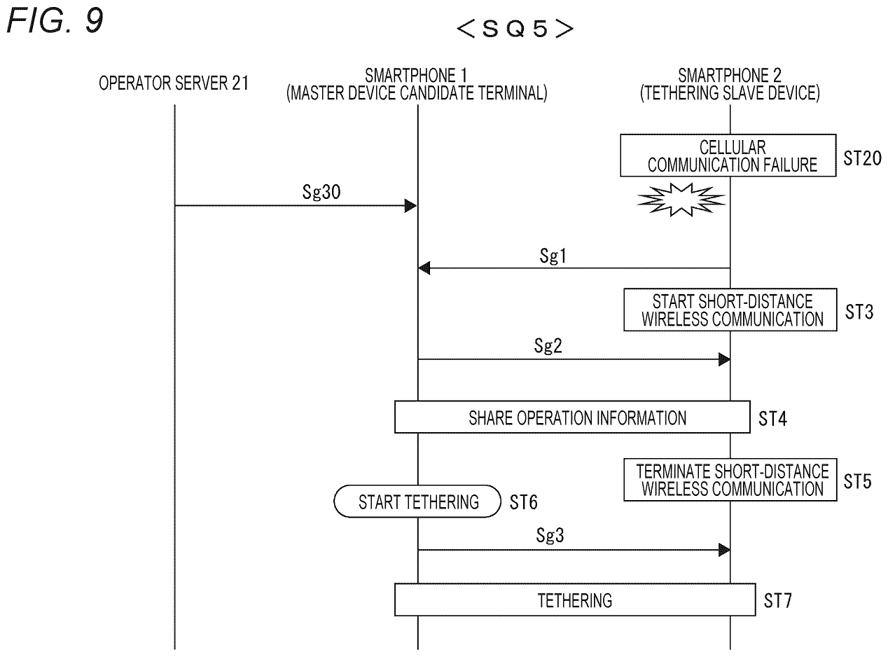

The processing in such a case is illustrated in FIG. 9 as a fifth sequence example (sequence SQ5). FIG. 9 illustrates processing of the operator server 21 and the smartphones 1 and 2 illustrated in FIGS. 8A and 8B.

The smartphone 1 is a communication terminal apparatus that uses a SIM of an operator in which a network failure has not occurred, and the smartphone 2 is a communication terminal apparatus that uses a SIM of an operator (not illustrated) in which a network failure has occurred.

As a state ST20, it is assumed that a failure occurs in cellular communication contracted by the smartphone 2 due to a disaster or the like, and communication is disabled.

In such a case, the communicable operator server 21 transmits an all-permission mode-on instruction signal Sg30 to the contracted communication terminal apparatus such as the smartphone 1. With this arrangement, the all-permission mode of the smartphone 1 is turned on.

The smartphone 2 transmits a master device request signal Sg1 to surrounding communication terminal apparatuses in response to being unable to communicate due to a communication failure. Then, as a state ST3, the smartphone 2 starts short-distance wireless communication.

Since the all-permission mode is turned on, the smartphone 1 that has received the master device request signal Sg1 from the smartphone 2 transmits a participation signal Sg2 for the short-distance wireless communication to the smartphone 2 and starts communication even if the smartphone 2 does not included in the preset group.

Then, as a state ST4, the smartphone 1 and the smartphone 2 share operation information by short-distance wireless communication. Then, a master device is determined among the master device candidates for the smartphone 2. In the drawing, since the master device candidate is only the smartphone 1, the smartphone 1 determines itself as a master device. Although not illustrated, in a case where there are a plurality of master device candidates, the master device is determined by comparing the operation information among the master device candidates. In addition, an SSID and a password are also determined.

As a state ST5, the smartphone 2 terminates the short-distance wireless communication in response to the determination of the master device.

As a state ST6, the smartphone 1 starts tethering as a master device. The smartphone 1 transmits a beacon Sg3 and notifies the surroundings of the SSID.

As a state ST7, the smartphone 2 confirms the beacon Sg3, transmits a password, and starts tethering using the smartphone 1 as a master device.

As described above, a communication terminal apparatus using a SIM of an operator in which a communication failure has occurred can perform network communication by performing tethering using a communication terminal apparatus that uses a SIM of another operator.

### 3. Tethering at Outside of Communication Range or Like

Next, a case where tethering is performed using a communication terminal apparatus of another person as a master device when a communication terminal apparatus of a certain user becomes out of a communication range will be described.

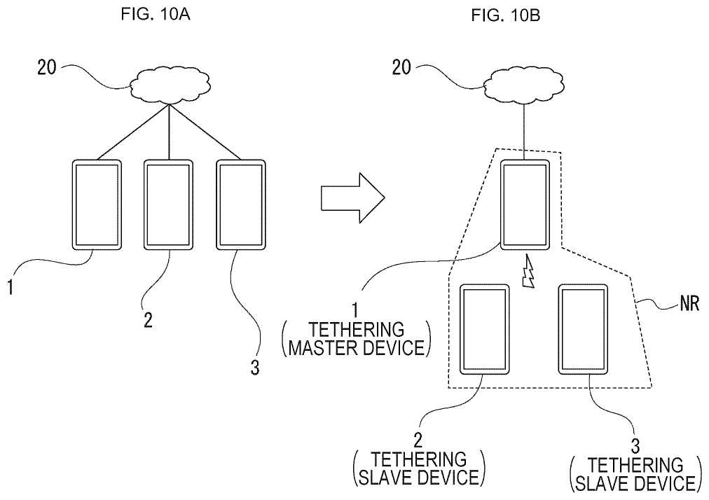

For example, the following cases are assumed.
Case where only a specific operator is in a service state due to being in deep in the mountain, remote islands, or the like
Case where a cellular is used, but communication is slow or difficult to be connected due to an insufficient contract packet capacity, or in a case where it is desired to preserve a packet capacity, or the like
Case of traveling abroad and having only one terminal that can perform roaming
Case where, when lost in the mountains or the like, it is desired to perform tethering using a communication terminal apparatus of someone who was lost together in the mountains FIG. 10A illustrates a situation where the smartphones 1, 2, and 3 are respectively performing communication via the network 20. It is assumed that the smartphone 1 and the smartphones 2 and 3 have different contracted operators.

At a certain point in time, it is assumed that only the smartphone 1 can perform network communication in the case described above. In that case, as illustrated in FIG. 10B, the smartphones 2 and 3 execute network communication by performing tethering using the smartphone 1 as a master device.

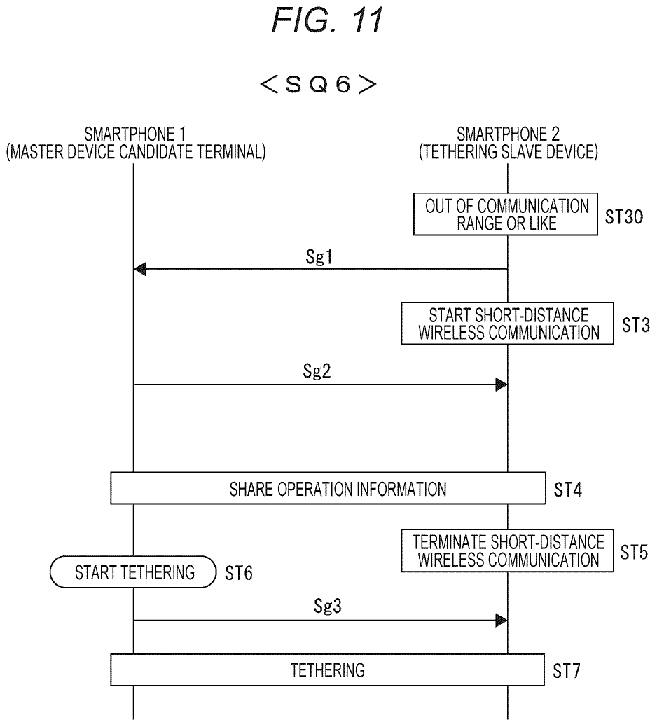

FIG. 11 illustrates a sequence SQ6 as a sixth sequence example. This is a situation where the smartphones 1 and 2 exist nearby, and only the smartphone 1 is within the communication range or the smartphone 1 becomes the communication terminal apparatus that can perform overseas roaming. In addition, for the smartphone 1, the smartphone 2 is included in a preset group.

As a state ST30, the smartphone 2 automatically transmits a master device request signal Sg1 in a case where itself becomes unable to communicate due to becoming out of the communication range or the like.

Note that instead of automatically transmitting the master device request signal Sg1 when itself becomes out of the communication range, a transmission execution operation of the master device request signal Sg1 may be enabled as a user interface, and tethering may be requested by the user's intention. In that case, the master device request signal Sg1 can be transmitted without necessarily being limited to a case of being outside of the communication range.

As a state ST3, the smartphone 2 that has transmitted the master device request signal Sg1 starts short-distance wireless communication.

The smartphone 1 that has received the master device request signal Sg1 from the smartphone 2 transmits a participation signal Sg2 for the short-distance wireless communication to the smartphone 2 since the smartphone 2 is included in the preset group, and starts communication.

Then, as a state ST4, the smartphone 1 and the smartphone 2 share operation information by the short-distance wireless communication, and determine a master device among master device candidates for the smartphone 2. In the drawing, since the master device candidate is only the smartphone 1, the smartphone 1 determines itself as a master device. In a case where there are a plurality of master device candidates, the master device is determined by comparing the operation information among the master device candidates. In addition, an SSID and a password are also determined.

As a state ST5, the smartphone 2 terminates the short-distance wireless communication in response to the determination of the master device.

As a state ST6, the smartphone 1 starts tethering as a master device. The smartphone 1 transmits a beacon Sg3 and notifies the surroundings of the SSID.

As a state ST7, the smartphone 2 confirms the beacon Sg3, transmits a password, and starts tethering using the smartphone 1 as a master device.

As described above, a communication terminal apparatus that becomes out of a communication range can perform network communication by performing tethering using a communication terminal apparatus that uses a SIM of an operator within the communication range.

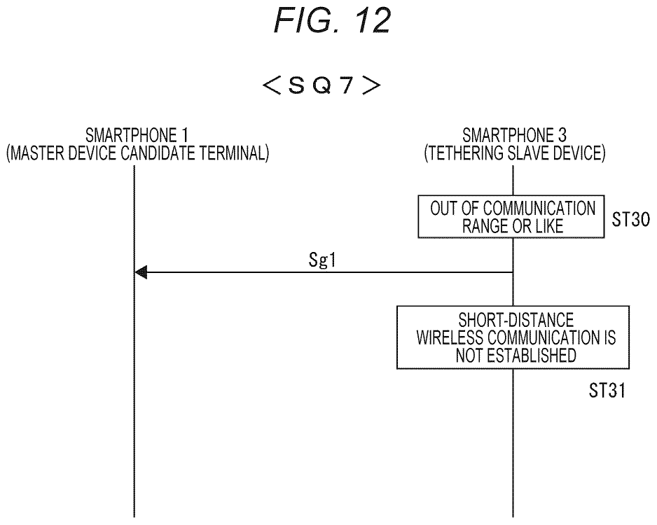

FIG. 12 illustrates a sequence SQ7 as a seventh sequence example, which is a case where the smartphone 3 is not included in the preset group for the smartphone 1 in a situation similar to the sequence SQ6.

As a state ST30, the smartphone 3 automatically transmits a master device request signal Sq1 in a case where itself becomes unable to communicate due to becoming out of the communication range or the like. Alternatively, the smartphone 3 may transmit the master device request signal Sg1 by the user operation.

On the other hand, since the smartphone 3 is not included in the preset group, the smartphone 1 ignores the master device request signal Sg1.

If no another communication terminal apparatus exists, the smartphone 3 cannot be tethered in such a case.

On the smartphone 3 side, the short-distance wireless communication is not established (state ST31), and another communication terminal apparatus cannot be set as a master device, and the processing ends.

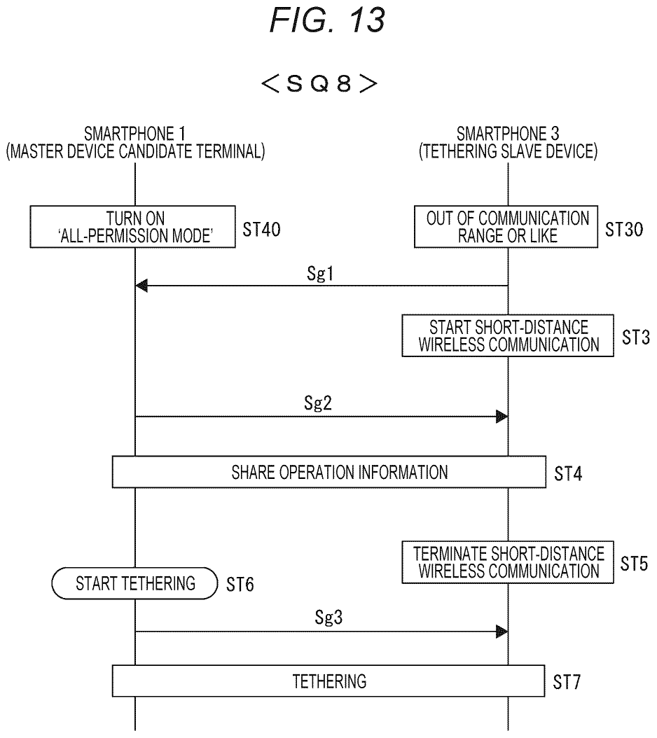

FIG. 13 illustrates a sequence SQ8 as an eighth sequence example, which is a case where an all-permission mode is turned on in the smartphone 1 in a situation similar to the sequence SQ7.

As a state ST40, an all-permission mode is turned on, on the smartphone 1 side.

As a state ST30, the smartphone 3 automatically transmits a master device request signal Sq1 in a case where itself becomes unable to communicate due to becoming out of the communication range or the like. Alternatively, the smartphone 3 may transmit the master device request signal Sg1 by the user operation.

As a state ST3, the smartphone 3 that has transmitted the master device request signal Sg1 starts short-distance wireless communication.

Even if the smartphone 3 is not included in the preset group, the smartphone 1 that has received the master device request signal Sg1 from the smartphone 3 transmits a participation signal Sg2 for the short-distance wireless communication to the smartphone 3 since the all-permission mode is turned on, and starts communication.

The others are similar to those in FIG. 11. That is, in a case such as the above-described case in which a communication terminal apparatus is located deep in the mountain, even if a tethering request comes from a communication terminal apparatus that is not included in the preset group for the communication terminal apparatus within the communication range, the communication terminal apparatus responds as a master device by turning on the all-permission mode.

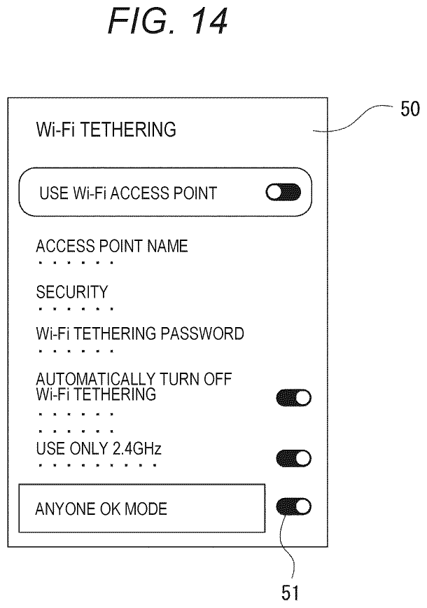

For example, a user interface as illustrated in FIG. 14 is provided. This is an example of a tethering setting screen 50, and a mode switch 51 that enables operation of on/off of the all-permission mode as the “anyone OK mode” is provided therein. With this arrangement, when the user of the communicable communication terminal apparatus turns on the all-permission mode using the mode switch 51, tethering can be enabled from the communication terminal apparatus that has become out of the communication range or the like, regardless of whether or not the communication terminal apparatus is included in the preset group.

### 4. Tethering in Specific Area

Next, tethering in a specific area will be described.

For example, in an area such as a cafe, an event venue, a live venue, or an exhibition venue, a certain communication terminal apparatus can be enabled to be used instead of free Wi-Fi.

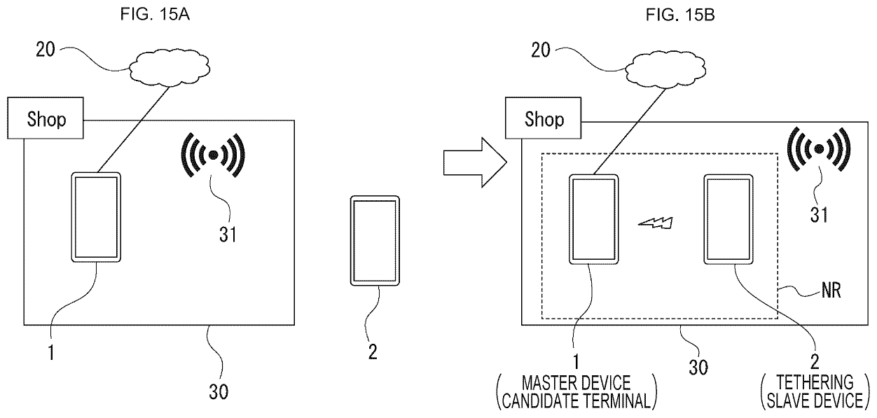

FIG. 15A illustrates a shop 30 such as a cafe, a smartphone 1 of a user in the shop, a smartphone 2 of a user outside the shop, a beacon transmitter 31 in the shop, and a network 20. The smartphone 1 is in a state capable of network communication.

Here, it is assumed that the user of the smartphone 2 enters the shop 30 as illustrated in FIG. 15B. Upon recognizing this, the smartphone 2 starts tethering using the smartphone 1 as a master device.

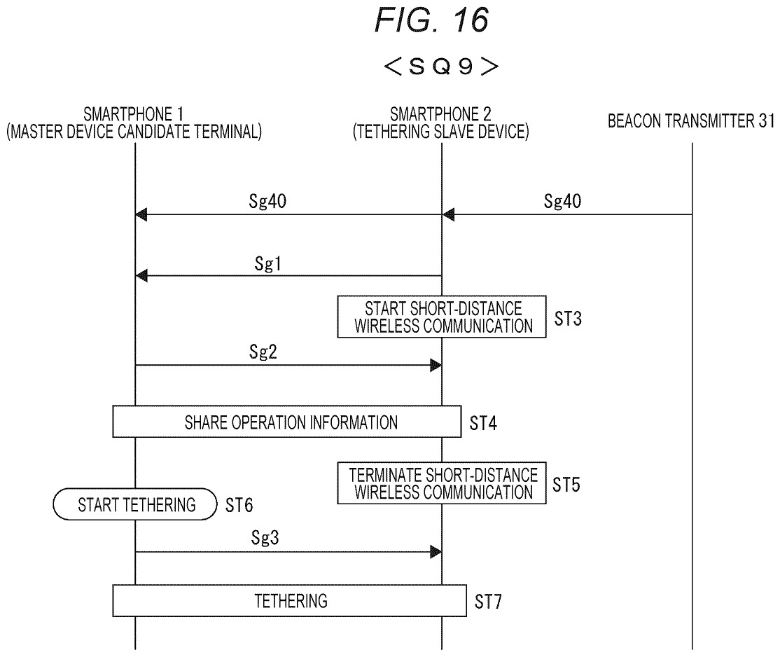

FIG. 16 illustrates a sequence SQ9 as a ninth sequence example. FIG. 16 illustrates processing of the smartphones 1 and 2, and the beacon transmitter 31 from when the state is changed from the state of FIG. 15A to the state of FIG. 15B, that is, when the smartphone 2 enters the shop 30. It is assumed that there is no communication terminal apparatus tethered as a master device in the shop 30 at the beginning.

When the smartphone 2 enters the shop 30, the smartphone 2 receives a beacon Sg40 from the beacon transmitter 31. The beacon Sg40 includes information indicating that the smartphone 2 is inside the shop 30, for example, an identification signal of the beacon transmitter 31. In addition, the smartphone 1 also receives the beacon Sg40.

The smartphone 2 that has entered the shop 30 and received the beacon Sg40 transmits the master device request signal Sg1.

The packet of the master device request signal Sg1 in this case includes a signal indicating that the smartphone 2 is inside the shop 30, for example, an identification signal included in the beacon Sg40.

In addition, as a state ST3, the smartphone 2 starts short-distance wireless communication.

The smartphone 1 that has received the master device request signal Sg1 from the smartphone 2 can determine that the smartphone 2 exists in the shop 30 by collating a signal (identification signal or the like) included in the beacon Sg40 with a signal (identification signal) included in the master device request signal Sg1. That is, the smartphone 1 can recognize that “the slave device that has transmitted the master device request signal Sg1 is a user who wants to use tethering in the shop 30”. Therefore, the smartphone 1 transmits a participation signal Sg2 for the short-distance wireless communication to the smartphone 2 and starts communication.

Then, as a state ST4, the smartphone 1 and the smartphone 2 share operation information by the short-distance wireless communication, and determine a master device among master device candidates for the smartphone 2. In the drawing, since the master device candidate is only the smartphone 1, the smartphone 1 is determined to be the master device. In a case where there are a plurality of master device candidates, the master device is determined by comparing the operation information among the master device candidates. In addition, an SSID and a password are also determined.

As a state ST5, the smartphone 2 terminates the short-distance wireless communication in response to the determination of the master device.

As a state ST6, the smartphone 1 starts tethering as a master device. The smartphone 1 transmits a beacon Sg3 and notifies the surroundings of the SSID.

As a state ST7, the smartphone 2 confirms the beacon Sg3, transmits a password, and starts tethering using the smartphone 1 as a master device.

As described above, tethering in the specific area can be started.

Such tethering makes it possible to provide added value to visitors to the specific area. For example, it is possible to provide an advantage that a specific website is connected via tethering and special content is distributed, or a shop side pays a fee for communication in the shop when a questionnaire is distributed and answered.

Note that in the sequences SQ4, SQ5, SQ6, SQ7, SQ8, and SQ9, the short-distance wireless communication is performed to determine the master device on the master device candidate side as in the sequence SQ1. However, as in the sequence SQ2, a modification is also conceivable in which the communication terminal apparatus that has transmitted the master device request signal Sg1 collects information of surrounding communication terminal apparatuses to determine the master device.

### 5. Configuration of Communication Terminal Apparatus

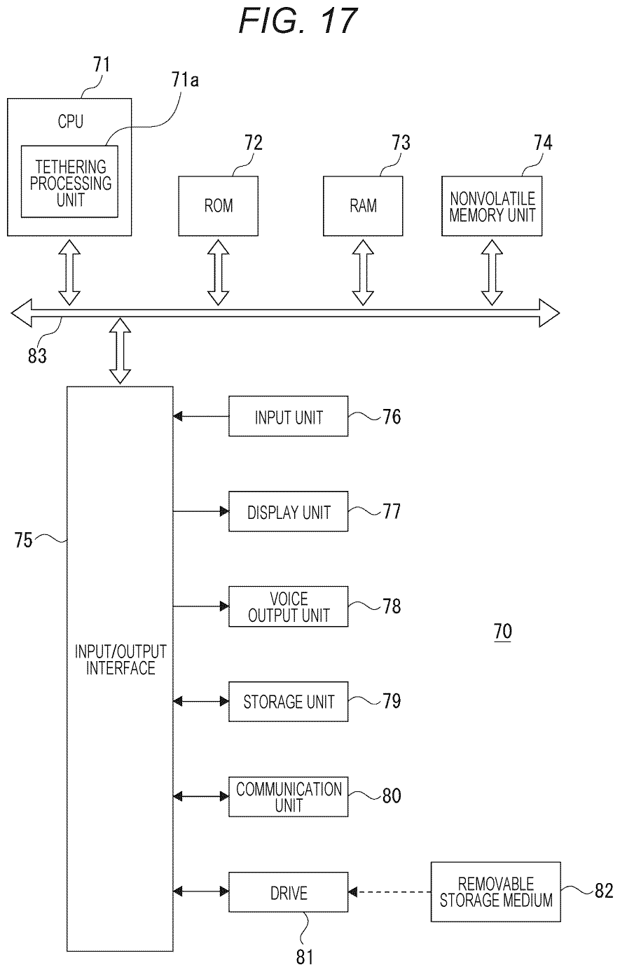

FIG. 17 illustrates a configuration example of a communication terminal apparatus such as the smartphones 1, 2, 3, and 5 and the game machine 4 described above.

A communication terminal apparatus 70 in FIG. 17 is a device that has a microprocessor and can perform information processing and communication. Specifically, the communication terminal apparatus 70 is a mobile terminal apparatus such as a smartphone, a tablet, a game machine, or a notebook type personal computer.

Note that the operator server 21 is assumed to have a substantially similar configuration.

A central processing unit (CPU) 71 of the communication terminal apparatus 70 illustrated in FIG. 17 executes various types of processing in accordance with a program stored in a nonvolatile memory unit 74 such as a read only memory (ROM) 72 or an electrically erasable programmable read-only memory (EEP-ROM), or a program loaded from a storage unit 79 to a random access memory (RAM) 73. The RAM 73 also stores, as appropriate, data and the like necessary for the CPU 71 to execute the various types of processing.

As one of functions realized by software in the CPU 71, a tethering processing unit 71a is provided. The tethering processing unit 71a has a processing function for executing the sequence SQ1 to the sequence SQ9 described above. A specific processing example will be described later.

Note that the communication terminal apparatus 70 may include a CPU, a graphics processing unit (GPU), general-purpose computing on graphics processing units (GPGPU), an artificial intelligence (AI) processor, or the like that is separate from the CPU 71.

The CPU 71, the ROM 72, the RAM 73, and the nonvolatile memory unit 74 are connected to one another via a bus 83. In addition, an input/output interface 75 is also connected to the bus 83.

An input unit 76 including a controller or an operation device is connected to the input/output interface 75. For example, as the input unit 76, various types of controllers and operation devices such as a keyboard, a mouse, keys, a trackball, a dial, a touch panel, a touch pad, and a remote controller are assumed.

A user operation is detected by the input unit 76, and a signal corresponding to an input operation is interpreted by the CPU 71.

A microphone is also assumed as the input unit 76. It is also possible to input voices uttered by the user as operation information.

In addition, a display unit 77 including a liquid crystal display (LCD), an organic electro-luminescence (EL) panel, and the like, and a voice output unit 78 including a speaker and the like are integrally or separately connected to the input/output interface 75.

The display unit 77 performs various types of display. The display unit 77 is configured by, for example, a display device provided in a housing of the communication terminal apparatus 70, a separate display device connected to the communication terminal apparatus 70, or the like.

The display unit 77 displays various types of images, operation menus, icons, messages, and the like, that is, performs display as a graphical user interface (GUI), on a display screen on a basis of instruction from the CPU 71.

The storage unit 79 including a hard disk drive (HDD), a solid state drive (SSD), and the like, or a communication unit 80 may be connected to the input/output interface 75.

The storage unit 79 can store various types of data and programs. A database can be configured in the storage unit 79.

The communication unit 80 comprehensively indicates functions for performing various types of communication such as cellular communication, communication via a transmission path such as the Internet, short-distance wireless communication, wired/wireless communication with various types of devices such as an external database and a communication terminal apparatus, infrared communication, and bus communication.

A drive 81 is also connected to the input/output interface 75 as necessary, and a removable storage medium 82 such as a magnetic disk, an optical disc, a magneto-optical disk, or a semiconductor memory is appropriately mounted thereon.

The drive 81 enables reading video data, various types of computer programs, and the like from the removable storage medium 82. The read data is stored in the storage unit 79, and videos and voices included in the data are output from the display unit 77 and the voice output unit 78. In addition, the computer programs and the like read from the removable storage medium 82 are installed in the storage unit 79 as necessary.

In the communication terminal apparatus 70, for example, software for the processing according to the present embodiment can be installed via network communication by the communication unit 80 or the removable storage medium 82. Alternatively, the software may be stored in advance in the ROM 72, the storage unit 79, or the like.

### 6. Processing Example of Communication Terminal Apparatus

A processing example of the communication terminal apparatus 70 such as the smartphones 1, 2, 3, and 5 and the game machine 4 described above, particularly a processing example of the CPU 71 by the function of the tethering processing unit 71a will be described.

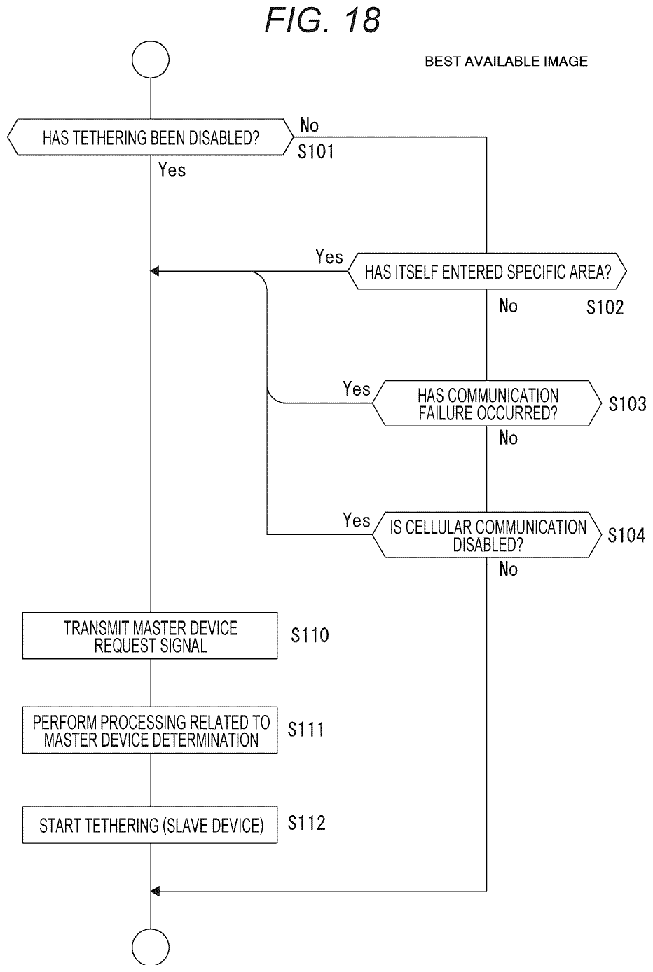

FIG. 18 illustrates a processing example of the CPU 71 of the communication terminal apparatus 70 in a case of requesting tethering as a slave device.

The CPU 71 repeatedly executes the determination from step S101 to step S104, for example, at predetermined time intervals.

In step S101, the CPU 71 determines whether or not tethering has been disabled during execution of tethering as a slave device. That is, it is determined whether or not the situation of the smartphone 3 in the sequences SQ1, SQ2, SQ3, and SQ4 has occurred.

If yes, the CPU 71 proceeds to step S110 and controls transmission of the master device request signal Sg1.

In step S111, the CPU 71 performs processing related to master device determination. For example, as in the sequence SQ1, the CPU 71 receives a participation signal Sg2 from the surrounding communication terminal apparatuses, performs information sharing by short-distance wireless communication, acquires information regarding the master device determined by the surrounding communication terminal apparatuses as the master device candidates, and then performs processing of terminating the short-distance wireless communication.

Alternatively, for example, as in the sequence SQ2, the CPU 71 receives the operation information signal Sg10 from the surrounding communication terminal apparatuses, determines a master device among the surrounding communication terminal apparatuses on a basis of the operation information signal Sg10, and performs processing of transmitting information related to the master device to the surrounding communication terminal apparatuses.

Then, in step S112, the CPU 71 starts tethering as a slave device in response to the beacon Sg3 from the communication terminal apparatus that has become the master device.

Through the above processing, the processing as the smartphone 3 in the sequences SQ1, SQ2, SQ3, and SQ4 is executed.

In step S102, the CPU 71 confirms whether or not itself has entered a specific area, for example, the shop 30 described with reference to FIGS. 15 and 16. For example, the determination is made by receiving the beacon Sg40.

When it is determined that itself has entered the specific area, the CPU 71 performs the processing of steps S110, S111, and S112. As described above, the processing as the smartphone 2 in the sequence SQ9 is executed.

In step S103, the CPU 71 confirms whether or not a communication failure has occurred on the operator side. When it is determined that the communication failure has occurred, the CPU 71 performs processing of steps S110, S111, and S112. As described above, the processing as the smartphone 2 in the sequence SQ5 is executed.

In step S104, the CPU 71 confirms whether or not the cellular communication is disabled. For example, it is whether or not itself is outside of the communication range. If it is determined that the cellular communication is disabled, the CPU 71 performs the processing of steps S110, S111, and S112. As described above, the processing as the smartphone 2 in the sequence SQ6 and the processing as the smartphone 3 in the sequences SQ7 and SQ8 are executed.

Note that in the above processing, the CPU 71 automatically transmits the master device request signal Sg1 in step S110. However, an example is also conceivable in which the master device request signal Sg1 is not automatically transmitted in step S110 but is transmitted in a case where the user performs an operation.

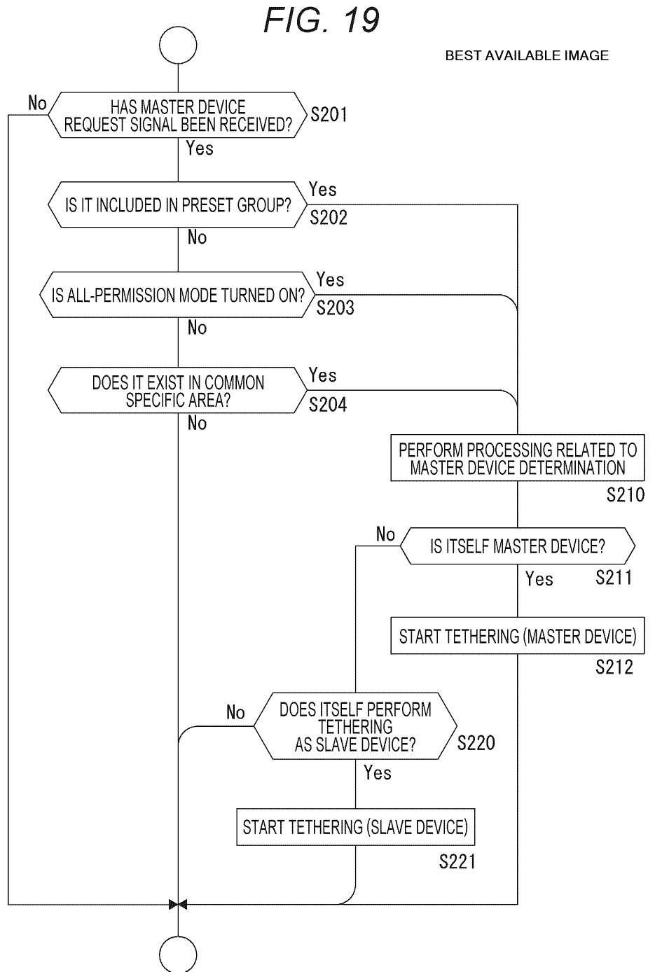

FIG. 19 illustrates a processing example of the communication terminal apparatus 70 that has received the master device request signal Sg1. The CPU 71 repeatedly executes the processing of FIG. 19.

In step S201, the CPU 71 determines whether or not the master device request signal Sg1 has been received. If not, the processing of FIG. 19 ends.

In a case where the master device request signal Sg1 has been received, the communication terminal apparatus 70 determines in step S202 whether or not a transmission source of the master device request signal Sg1 is included in the preset group. If the transmission source is included in the preset group, the processing proceeds to step S210.

In addition, when the transmission source of the master device request signal Sg1 is not included in the preset group, the CPU 71 proceeds to step S203, and confirms whether or not an all-permission mode is currently turned on. When the all-permission mode is turned on, the processing proceeds to step S210.

In addition, in a case where the all-permission mode is off, the CPU 71 proceeds to step S204 and confirms whether or not the transmission source of the master device request signal Sq1 and itself exist in a common specific area. For example, an identification signal included in the beacon Sg40 from the beacon transmitter 31 in FIGS. 15 and 16 is collated with an identification signal included in the master device request signal Sg1. Then, when the CPU 71 determines that the transmission source of the master device request signal Sg1 and the CPU 71 are in the common specific area, the processing proceeds to step S210, and if they are not in the common specific area, the processing of FIG. 19 ends.

In step S210, the CPU 71 performs processing related to master device determination. For example, as in the sequence SQ1, the CPU 71 transmits a participation signal Sg2 for the short-distance wireless communication started by the communication terminal apparatus that is the transmission source of the master device request signal Sg1, performs information sharing, and performs processing of comparing the operation information among the master device candidates to determine the master device.

Alternatively, for example, as in the sequence SQ2, the CPU 71 transmits the operation information signal Sg10 of itself to the communication terminal apparatus that is the transmission source of the master device request signal Sg1 and performs processing of receiving the tethering start request signal Sg11 or the tethering information signal Sg12.

In step S211, the CPU 71 branches the processing depending on whether or not itself becomes the master device. In the case where itself becomes a master device, tethering is started in step S212.

In a case where itself does not become a master device but becomes a slave device, the CPU 71 proceeds from step S220 to step S221 and starts tethering as a slave device.

In a case where itself becomes neither a master device nor a slave device, the processing of FIG. 19 ends as it is.

As described above, the processing of the smartphone 2 in the sequences SQ1, SQ2, SQ3, and SQ4, the processing of the smartphone 1 in the sequences SQ5 to SQ9, and the processing of the game machine 4 in the sequences SQ1, SQ2, and SQ3 are performed.

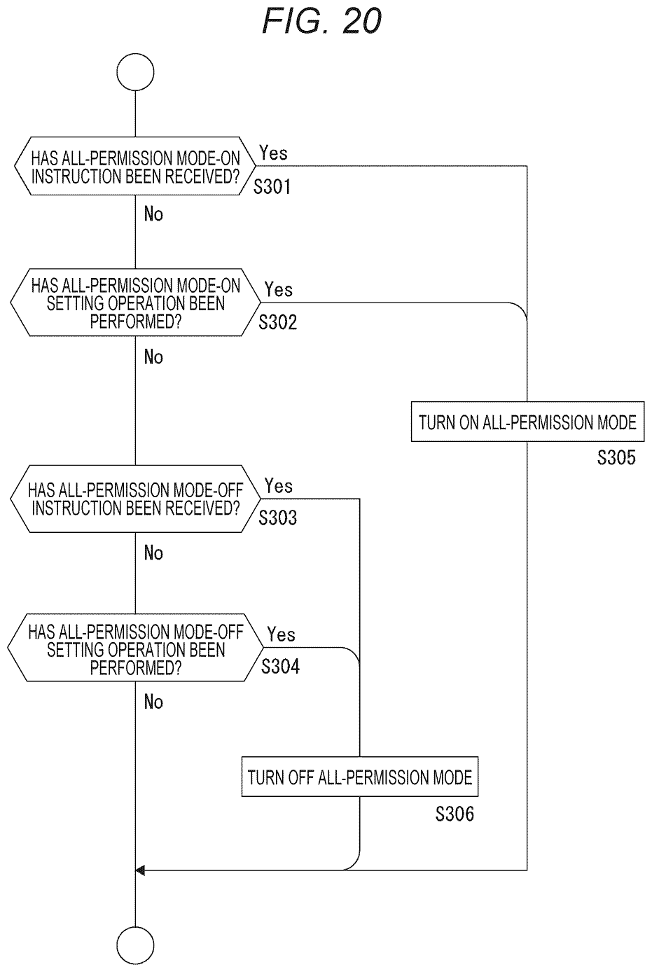

FIG. 20 illustrates processing related to an all-permission mode.

In step S301, the CPU 71 confirms whether or not an all-permission mode-on instruction has been received from the operator server 21. In a case where the all-permission mode-on instruction has been received, the CPU 71 turns on the all-permission mode in step S305.

In step S302, the CPU 71 determines whether or not the user has performed an all-permission mode-on setting operation. In a case where the operation has been performed, the CPU 71 turns on the all-permission mode in step S305.

In step S303, the CPU 71 confirms whether or not an all-permission mode-off instruction has been received from the operator server 21. In a case where the all-permission mode-off instruction is received, the CPU 71 turns off the all-permission mode in step S306.

In step S304, the CPU 71 determines whether or not the user has performed an all-permission mode-off setting operation. In a case where the operation has been performed, the CPU 71 turns off the all-permission mode in step S306.

The communication terminal apparatus 70 that performs the processing of FIGS. 18, 19, and 20 can perform tethering as a slave device after activating tethering using another communication terminal apparatus 70 as a master device, or can start tethering as a master device in response to the master device request signal Sg1. That is, the processing of any position of the smartphones 1, 2, 3, and 5 and the game machine 4 indicated in the sequence SQ1 to the sequence SQ9 is executed according to the situation.

Note that an example is also conceivable in which the communication terminal apparatus 70 has a processing function on the slave device side in FIG. 18, but does not have a processing function on the master device side in FIGS. 19 and 20.

In addition, an example is also conceivable in which the communication terminal apparatus 70 does not have a processing function on the slave device side in FIG. 18, but has a processing function on the master device side in FIGS. 19 and 20.

### 7. Summary and Modifications

According to the above-described embodiment, the following effects can be obtained.

The communication terminal apparatus 70 according to the embodiment includes a tethering processing unit 71a configured to transmit a master device request signal Sg1 to a communication terminal apparatus that is not executing tethering as a master device, and perform processing of starting tethering as a slave device via a tethering master device determined among communication terminal apparatuses to which the master device request signal Sg1 is transmitted.

With this arrangement, tethering can be performed via the newly determined master device in a situation where the tethering master device disappears during tethering as a slave device, or in a situation where it is desired to start tethering as a slave device in a state where the tethering master device disappears. That is, even if a master device that has activated the tethering processing does not exist in the surroundings, an appropriate master device can be selected and network connection can be established via tethering.

Specifically, for example, a communication terminal apparatus such as an individual smartphone is regarded as a public hot spot, and tethering can be performed from the smartphone or the like of another person.

In the embodiment, an example has been described in which the tethering processing unit 71a performs processing of starting tethering as a slave device via a tethering master device determined among a plurality of communication terminal apparatuses that has responded to the master device request signal Sg1.

In a case where the master device request signal Sg1 is transmitted to the surrounding communication terminal apparatuses, if any one is determined to be a master device, tethering is performed via that master device. By not specifying a master device from the beginning, it is possible to increase the possibility that an appropriate master device can be selected according to the situation.

In the embodiment, an example has been described in which the tethering processing unit 71a performs processing of starting tethering as a slave device via the tethering master device determined by the communication terminal apparatuses that have responded to the master device request signal Sg1 (see sequence SQ1 and the like).

In a case where the master device request signal Sg1 is transmitted to surrounding communication terminal apparatuses, the communication terminal apparatuses of one or more master device candidates as the transmission destination share the operation information to determine an appropriate master device. With this arrangement, a communication terminal apparatus with good operation conditions among the master device candidates can be set as the master device.

In the embodiment, an example has been described in which the tethering processing unit 71a acquires operation information from the communication terminal apparatuses that have responded to the master device request signal Sg1, determines a tethering master device on a basis of the operation information, and performs processing of starting tethering as a slave device (see sequence SQ2 and the like).

In a case where the master device request signal Sg1 is transmitted to surrounding communication terminal apparatuses, operation information related to tethering is acquired from the responding communication terminal apparatus. The tethering processing unit 71a compares the operation information of the respective communication terminal apparatuses and determines a master device having a good operation conditions. With this arrangement, a communication terminal apparatus with good operation conditions among the master device candidates can be set as the master device.

In the embodiment, an example has been described in which the tethering processing unit 71a performs transmission processing of the master device request signal Sg1 in response to tethering being disabled during execution of tethering as a slave device (see sequences SQ1 to SQ4, and FIG. 18).

When the master device is separated or communication is disabled during execution of tethering as a slave device and tethering is disabled, the master device request signal Sg1 is transmitted. With this arrangement, it is possible to increase the possibility of being able to perform tethering using a surrounding communication terminal apparatus that is not currently performing processing as a tethering master device as a new master device.

In the embodiment, an example has been described in which the tethering processing unit 71a performs transmission processing of the master device request signal Sg1 in response to reception of information indicating that the tethering processing unit has entered a specific area (see sequence SQ9 and FIG. 18).

For example, in a case where the entering a specific area such as a cafe, an event venue, a live venue, or an exhibition venue is detected, the master device request signal Sg1 is transmitted. With this arrangement, tethering can be performed using another communication terminal apparatus in the area as a master device, and the possibility of providing various services can be widened.

In the embodiment, an example has been described in which the tethering processing unit 71a performs transmission processing of the master device request signal Sg1 in response to the network communication being disabled in a state where tethering is not performed (see sequence SQ5 and FIG. 18).

For example, when network communication is disabled due to a network failure of an operator (telecommunication carrier), the master device request signal Sg1 is transmitted. With this arrangement, it is possible to perform tethering using another communication terminal apparatus contracted with another telecommunication carrier as a master device. It is also suitable for ensuring communication in an emergency.

In the embodiment, an example has been described in which the tethering processing unit 71a performs transmission processing of the master device request signal in response to the tethering processing unit becoming out of a communication range of a corresponding telecommunication carrier (see sequences SQ6 to SQ8, and FIG. 18).

For example, the master device request signal Sg1 is transmitted when the tethering processing unit becomes out of the communication range of the telecommunication carrier. With this arrangement, it is possible to perform tethering using, as a master device, a communication terminal apparatus contracted with another telecommunication carrier, that has not become out of the communication range. This is also effective in terms of ensuring communication in an emergency.

In the embodiment, an example has been described in which, in a case where a master device request signal Sg1 is received from another communication terminal apparatus, the tethering processing unit 71a performs processing as a master device candidate, by the another communication terminal apparatus being an apparatus belonging to a preset group (see FIG. 19).

Even when the master device request signal is transmitted from another communication terminal apparatus, if the communication terminal apparatus that is the transmission source does not belong to the preset group, the communication terminal apparatus does not become a master device candidate. With this arrangement, it is possible to prevent using the communication terminal apparatus of another person as the master device to perform tethering processing more than necessary.

In the embodiment, an example of the user interface for setting the preset group has been described. For example, as illustrated in FIG. 3, a user interface that allows the user to select a preset group is prepared. With this arrangement, the user can arbitrarily set a range in which the user is permitted to become a master device.

In the embodiment, an example has been described in which, in a case where the master device request signal Sg1 is received from another communication terminal apparatus, the tethering processing unit 71a performs processing as a master device candidate by turning on the all-permission mode in which the tethering processing unit always permits to become a master device candidate (see FIG. 19).

When the all-permission mode is turned on, even when the master device request signal is transmitted from a communication terminal apparatus not included in the preset group, the tethering processing unit becomes a master device candidate. With this arrangement, it is possible to increase the possibility of playing a role of the master device according to the situation.

In the embodiment, an example has been described in which the tethering processing unit 71a performs setting of the all-permission mode in response to a mode control signal transmitted from a corresponding operator server 21 (see FIG. 20).

For example, a server of the contracted telecommunication carrier can cause a communication terminal apparatus to turn on the all-permission mode. With this arrangement, in a case where a communication failure occurs in a certain telecommunication carrier, the communication terminal apparatus of the telecommunication carrier can be enabled for network communication by tethering. In addition, tethering can be widely enabled even at the time of disaster or the like, which can contribute to providing information.

In the embodiment, an example of the user interface for setting the all-permission mode has been described. For example, as described with reference to FIG. 14, the user can set on/off of the all-permission mode (“anyone OK mode”). With this arrangement, it is possible to cause the communication terminal apparatus to actively function as a tethering master device at the time of communication failure, disaster, or the like.

In the embodiment, an example has been described in which the tethering processing unit 71a performs processing as a master device candidate in a case where the master device request signal Sg1 is received from another communication terminal apparatus existing in a common specific area (see FIG. 19).

Even when the master device request signal is transmitted from a communication terminal apparatus in the same area, when being in a specific area such as a cafe, the tethering processing unit becomes a master device candidate. With this arrangement, tethering in the specific area can be easily performed.

In the embodiment, an example has been described in which, the tethering processing unit 71a performs sharing of operation information with a communication terminal apparatus of another master device candidate and performs processing of determining a master device, in a case of performing processing as a master device candidate in response to the master device request signal Sg1 from another communication terminal apparatus (see sequences SQ1 and the like, and step S210 in FIG. 19).

In response to becoming a master device candidate in response to the master device request signal Sq1, the master device candidates share the operation information to determine the master device, whereby the most suitable master device can be selected.

Here, a charge form that can be provided by the operator will be described.

It is conceivable that, with respect to a user who allows his/her own communication terminal apparatus 70 to be operated as a master device, the user is allowed to obtain a benefit from the operator by turning on the all-permission mode. For example, a communication packet as a master device is not charged. Alternatively, a communication packet fee may not be generated when the all-permission mode is forcibly turned on by the all-permission mode-on instruction signal from the operator server 21 at the time of disaster or the like.

In addition, there is also a point service and a discount. For example, it is conceivable to provide a service such as a service in which a packet is pointed back by the amount of the packet used while being connected to the slave device when operating as a master device or a service in which a point is accumulated on a master device side when an unknown person is connected.

In addition, it is also conceivable that a point magnification is increased by one time if a user of a preset group is connected to become a master device, and points are multiplied if an unknown person is connected to become a master device.

For users who want to connect their slave devices to a master device of another user of the same operator, it is conceivable that the users are allowed to use the service for a fixed monthly fee, or that communication packet charges for a master device side be borne by a slave device side.

The program according to the embodiment is a program for causing a processor, for example, a CPU, a digital signal processor (DSP), or the like, or a device including the processor to execute the processing illustrated in FIGS. 18, 19, and 20 described above.

That is, the program according to the embodiment is a program for causing an arithmetic processing apparatus of a communication terminal apparatus to execute processing of: transmitting a master device request signal Sg1 to a communication terminal apparatus that is not executing tethering as a master device; and starting tethering as a slave device via a tethering master device determined among communication terminal apparatuses to which the master device request signal Sg1 is transmitted.

With such a program, the communication terminal apparatus 70 according to the embodiment can be realized.

The program according to the embodiment described above can be stored in advance in an HDD as a storage medium built in a device such as a computer apparatus, a ROM in a microcomputer including a CPU, or the like. In addition, such a program can be temporarily or permanently stored (recorded) in a removable storage medium such as a flexible disk, a compact disc read only memory (CD-ROM), a magneto optical (MO) disk, a digital versatile disc (DVD), a Blu-ray Disc (registered trademark), a magnetic disk, a semiconductor memory, or a memory card. Such a removable storage medium can be provided as so-called package software.

In addition, such a program may be installed from the removable storage medium into a personal computer and the like, or may be downloaded from a download site via a network such as a local area network (LAN) or the Internet.

In addition, such a program is suitable for providing the communication terminal apparatus 70 according to the embodiment in various ways. For example, by downloading the program to a mobile terminal apparatus such as a smartphone or a tablet, a mobile phone, a gaming device, a video device, a personal computer, a personal digital assistant (PDA), or the like, it is possible to cause these apparatuses to function as the communication terminal apparatus 70 of the present disclosure.

Note that the effects described in the present specification are merely examples and are not limited thereto, and another effect may be provided.

Note that the present technology may also have the following configurations.

(1)

A communication terminal apparatus including
a tethering processing unit configured to transmit a master device request signal to a communication terminal apparatus that is not executing tethering as a master device, and perform processing of starting tethering as a slave device via a tethering master device determined among communication terminal apparatuses to which the master device request signal is transmitted.
   (2)

The communication terminal apparatus according to (1), in which
the tethering processing unit performs processing of starting tethering as a slave device via a tethering master device determined among a plurality of communication terminal apparatuses that has responded to the master device request signal.
   (3)

The communication terminal apparatus according to (1) or (2), in which
the tethering processing unit performs processing of starting tethering as a slave device via a tethering master device determined by the communication terminal apparatuses that have responded to the master device request signal.
   (4)

The communication terminal apparatus according to (1) or (2), in which
the tethering processing unit acquires operation information from communication terminal apparatuses that have responded to the master device request signal, determines a tethering master device on a basis of the operation information, and performs processing of starting tethering as a slave device.
   (5)

The communication terminal apparatus according to any one of (1) to (4), in which
the tethering processing unit performs transmission processing of the master device request signal in response to tethering being disabled during execution of tethering as a slave device.
   (6)

The communication terminal apparatus according to any one of (1) to (5), in which
the tethering processing unit performs transmission processing of the master device request signal in response to reception of information indicating that the tethering processing unit has entered a specific area.
   (7)

The communication terminal apparatus according to any one of (1) to (6), in which
the tethering processing unit performs transmission processing of the master device request signal in response to communication being disabled due to a network failure of a telecommunication carrier in a state where tethering is not performed.
   (8)

The communication terminal apparatus according to any one of (1) to (7), in which
the tethering processing unit performs transmission processing of the master device request signal in response to the tethering processing unit becoming out of a communication range of a corresponding telecommunication carrier.
   (9)

The communication terminal apparatus according to any one of (1) to (8), in which
in a case where the master device request signal is received from another communication terminal apparatus, the tethering processing unit performs processing as a master device candidate, by the another communication terminal apparatus being an apparatus belonging to a preset group.
   (10)

The communication terminal apparatus according to (9), further including
a user interface for setting the preset group.
   (11)

The communication terminal apparatus according to any one of (1) to (10), in which
in a case where the master device request signal is received from another communication terminal apparatus, the tethering processing unit performs processing as a master device candidate by turning on an all-permission mode in which the tethering processing unit always permits to become a master device candidate.
   (12)

The communication terminal apparatus according to (11), in which
the tethering processing unit performs setting of the all-permission mode in response to a mode control signal transmitted from a corresponding server apparatus.
   (13)

The communication terminal apparatus according to (11) or (12), further including
a user interface for setting the all-permission mode.
   (14)

The communication terminal apparatus according to any one of (1) to (13), in which
the tethering processing unit
performs processing as a master device candidate in a case where a master device request signal is received from another communication terminal apparatus existing in a common specific area.
   (15)

The communication terminal apparatus according to any one of (1) to (14), in which
the tethering processing unit
performs sharing of operation information with a communication terminal apparatus of another master device candidate and performs processing of determining a master device, in a case of performing processing as a master device candidate in response to the master device request signal from another communication terminal apparatus.
   (16)

A tethering processing method including:
by a communication terminal apparatus,
transmitting a master device request signal to a communication terminal apparatus that is not executing tethering as a master device; and performing processing of starting tethering as a slave device via a tethering master device determined among communication terminal apparatuses to which the master device request signal is transmitted.
   (17)

A program for causing an arithmetic processing apparatus of a communication terminal apparatus to execute:
transmitting a master device request signal to a communication terminal apparatus that is not executing tethering as a master device; and processing of starting tethering as a slave device via a tethering master device determined among communication terminal apparatuses to which the master device request signal is transmitted.

### REFERENCE SIGNS LIST

1, 2, 3, 5 Smartphone
4 Game machine
20 Network
21 Operator server
30 Shop
31 Beacon transmitter
70 Communication terminal apparatus
71 CPU
71a Tethering processing unit
Sg1 Master device request signal
Sg2 Participation signal
Sg3 Beacon
Sg10 Operation information signal
Sg11 Tethering start request signal
Sg12 Tethering information signal
Sg30 All-permission mode-on instruction signal

1. A communication terminal apparatus comprising
a tethering processing unit configured to transmit a master device request signal to a communication terminal apparatus that is not executing tethering as a master device, and perform processing of starting tethering as a slave device via a tethering master device determined among communication terminal apparatuses to which the master device request signal is transmitted.

2. The communication terminal apparatus according to claim 1, wherein
the tethering processing unit performs processing of starting tethering as a slave device via a tethering master device determined among a plurality of communication terminal apparatuses that has responded to the master device request signal.

3. The communication terminal apparatus according to claim 1, wherein
the tethering processing unit performs processing of starting tethering as a slave device via a tethering master device determined by the communication terminal apparatuses that have responded to the master device request signal.

4. The communication terminal apparatus according to claim 1, wherein
the tethering processing unit acquires operation information from communication terminal apparatuses that have responded to the master device request signal, determines a tethering master device on a basis of the operation information, and performs processing of starting tethering as a slave device.

5. The communication terminal apparatus according to claim 1, wherein
the tethering processing unit performs transmission processing of the master device request signal in response to tethering being disabled during execution of tethering as a slave device.

6. The communication terminal apparatus according to claim 1, wherein
the tethering processing unit performs transmission processing of the master device request signal in response to reception of information indicating that the tethering processing unit has entered a specific area.

7. The communication terminal apparatus according to claim 1, wherein
the tethering processing unit performs transmission processing of the master device request signal in response to communication being disabled due to a network failure of a telecommunication carrier in a state where tethering is not performed.

8. The communication terminal apparatus according to claim 1, wherein
the tethering processing unit performs transmission processing of the master device request signal in response to the tethering processing unit becoming out of a communication range of a corresponding telecommunication carrier.

9. The communication terminal apparatus according to claim 1, wherein
in a case where the master device request signal is received from another communication terminal apparatus, the tethering processing unit performs processing as a master device candidate, by the another communication terminal apparatus being an apparatus belonging to a preset group.

10. The communication terminal apparatus according to claim 9, further comprising
a user interface configured to set the preset group.

11. The communication terminal apparatus according to claim 1, wherein
in a case where the master device request signal is received from another communication terminal apparatus, the tethering processing unit performs processing as a master device candidate by turning on an all-permission mode in which the tethering processing unit always permits to become a master device candidate.

12. The communication terminal apparatus according to claim 11, wherein
the tethering processing unit performs setting of the all-permission mode in response to a mode control signal transmitted from a corresponding server apparatus.

13. The communication terminal apparatus according to claim 11, further comprising
a user interface configured to set the all-permission mode.

14. The communication terminal apparatus according to claim 1, wherein
the tethering processing unit
performs processing as a master device candidate in a case where a master device request signal is received from another communication terminal apparatus existing in a common specific area.

15. The communication terminal apparatus according to claim 1, wherein
the tethering processing unit
performs sharing of operation information with a communication terminal apparatus of another master device candidate and performs processing of determining a master device, in a case of performing processing as a master device candidate in response to the master device request signal from another communication terminal apparatus.

16. A tethering processing method comprising:
by a communication terminal apparatus,
transmitting a master device request signal to a communication terminal apparatus that is not executing tethering as a master device; and performing processing of starting tethering as a slave device via a tethering master device determined among communication terminal apparatuses to which the master device request signal is transmitted.

17. A program for causing an arithmetic processing apparatus of a communication terminal apparatus to execute:
transmitting a master device request signal to a communication terminal apparatus that is not executing tethering as a master device; and processing of starting tethering as a slave device via a tethering master device determined among communication terminal apparatuses to which the master device request signal is transmitted.
